(19) United States
(12) Patent Application Publication
(10) Pub. No.: US 2007/0145891 A1
(43) Pub. Date: Jun. 28, 2007

(54) Display device

(75) Inventor: Jeroen Hubert Christoffel Jacobus Stessen, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/546,339

(22) PCT Filed: Feb. 12, 2004
(86) PCT No.: PCT/IB04/50101

§ 371 Date: Nov. 13, 2006

(30) Foreign Application Priority Data
Feb. 24, 2003 (EP) 03100438.5

(51) Int. Cl. H01J 1/62; H01J 63/04

(52) U.S. Cl. 313/506

(57) ABSTRACT

The invention relates to a backlighting arrangement for a light valve display device, such as an LCD-display. The backlighting arrangement comprises a number of elongated light emitting structures (9) arranged in a layer (5), extending in a plane, which structures emit light along their lengths in the direction of a light valve layer (1). An optics layer (7), comprising a number of elongated lenses (11), is placed between the light emitting structures (9) and the light valve layer (1). Each such lens (11) concentrates light emitted by a number of light emitting structures (9) onto a number of elongated areas on the light valve layer (1). Preferably, each light emitting structure (9) emits light of one primary colour only, and the elongated lenses concentrate the light emitted from each light emitting structure onto sub-pixel areas intended for a corresponding colour, so that a colour display may be provided without the use of colour filters.

The present invention relates to a light valve display device, comprising a light valve layer, extending in a first plane, and a backlighting arrangement, comprising a number of elongated light emitting structures, in a layer extending in a second plane, which is parallel to the first plane, which light emitting structures are arranged to emit light along their lengths in the direction of the light valve layer.

Such a display device is described in EP, A2, 1211551. The main advantage with display devices of this kind is that they allow the possibility of separately generating light of different colours, and projecting the different colours separately onto the back of the light valve layer. This specifically makes possible, in colour displays, the omission of colour filters, which provides for display devices consuming less energy. Generally it provides for the possibility to illuminate different areas on a light valve layer differently.

A problem with display devices of the above mentioned kind is that they require relatively detailed structures. For instance, to obtain the desired effect, one elongated light emitting structure is required for each sub-pixel column in the light valve layer.

An object of the present invention is to wholly or partially obviate the above mentioned problem.

This object is achieved with a display device according to the opening paragraph, further comprising a number of elongated lenses with convex cross section, which are arranged in a layer, extending in a third plane, which is parallel to, and placed between, the first and second planes, the elongated lenses extending in the same direction as the light emitting structures, such that each lens focuses the light emitted from a light emitting structure onto an elongated area of the light valve layer. This allows relatively coarse light emitting structures to be used, since the lenses provide the capability to focus the light onto a narrow elongated area on the light valve layer, which area may correspond to a sub-pixel column.

Preferably, each lens focuses light from a plurality of light emitting structures onto a corresponding number of areas on the light valve layer. This provides not only for the use of even coarser light emitting structures, but also entails improved uniformity of the illumination and improved viewing angle for the display device.

Preferably, each light emitting structure is devised to emit light of one colour only. This provides a colour display where colour filters need not be used.

In a preferred embodiment, each of the light emitting structures emit light with one of the primary colours red, green and blue. This enables the display to function e.g. as a colour TV.

In an alternative embodiment, each of the light emitting structures emit light having one of the colours red, yellow-green, cyan-green and blue. This entails a wider colour gamut, which allows better colour reproduction.

In a preferred embodiment, each light emitting structure comprises a light guide, fed by a light emitting diode. This provides a simple and reliable structure.

In an alternative embodiment, each light emitting structure comprises a light guide, and a bright light source is arranged to feed a number of light emitting structures. This allows the use of fewer light sources.

In yet another alternative embodiment, each light emitting structure comprises a column of light emitting diodes. This provides for powerful lighting and allows the light emission to be varied also along the length of each light emitting structure.

Preferably, the light valve display device is a liquid crystal display device, and a liquid crystal layer constitutes the light valve layer.

These and other aspects of the invention will be apparent from and elucidated with reference to the embodiments described hereinafter.

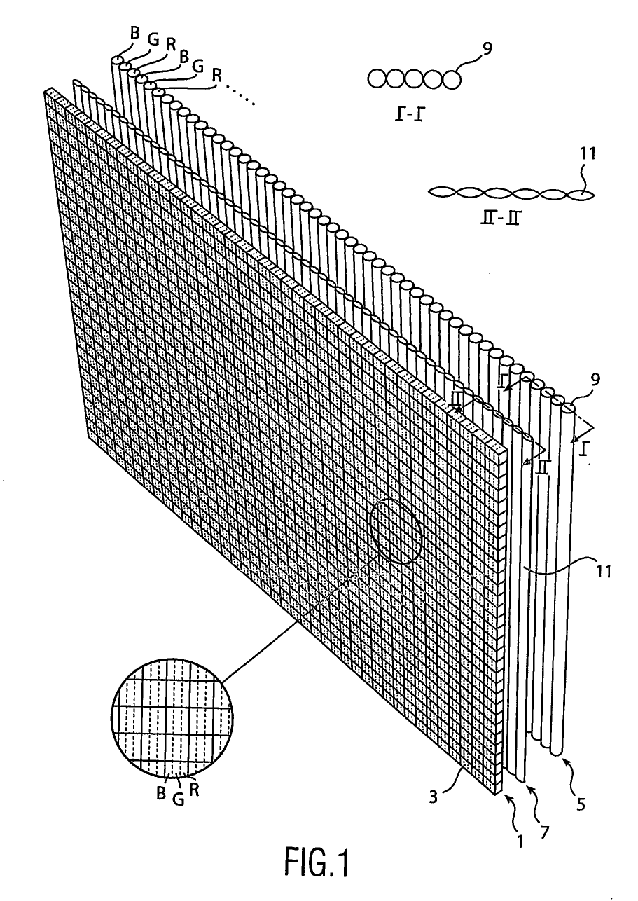

FIG. 1 is a schematic perspective view of a display device according to an embodiment of the invention.

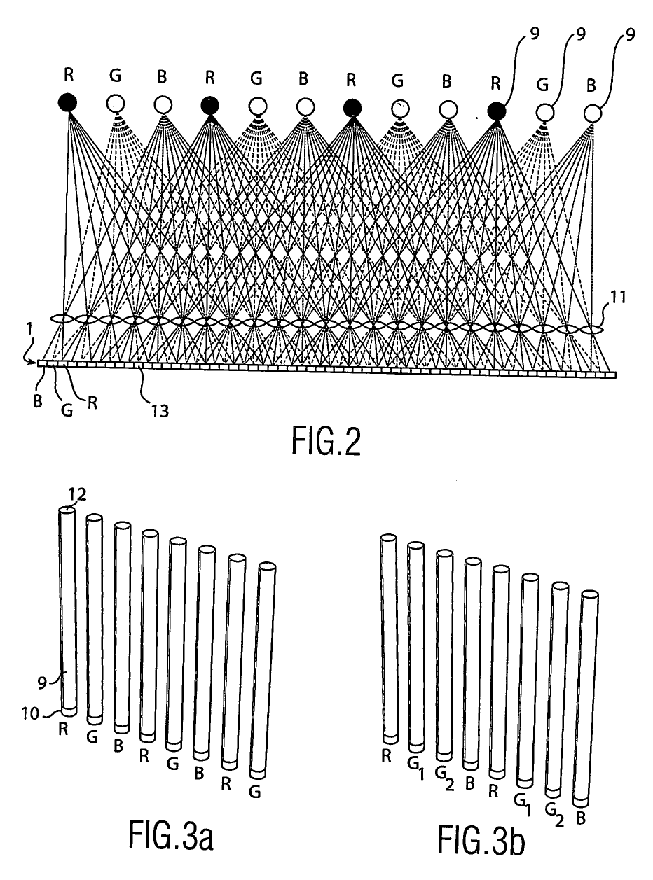

FIG. 2 shows a cross section of a preferred embodiment of the display device in FIG. 1.

FIG. 3 illustrates a preferred embodiment of the elongated light emitting structures used in FIG. 1.

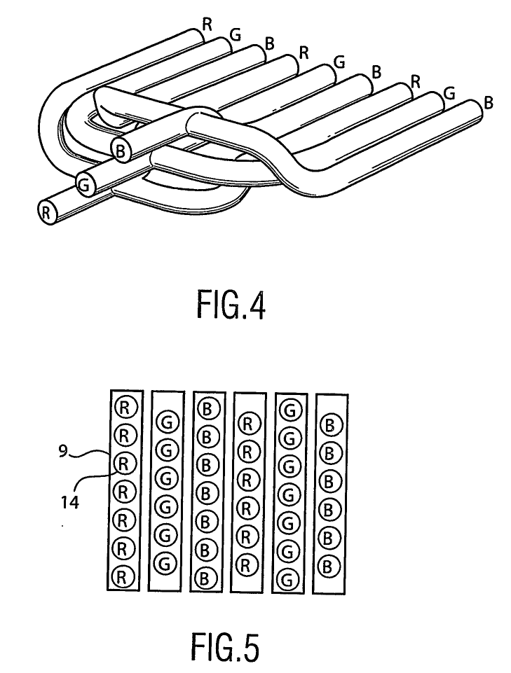

FIG. 4 illustrates an alternative embodiment of the elongated light emitting structures used in FIG. 1.

FIG. 5 illustrates another alternative embodiment of the elongated light emitting structures.

FIG. 1 is a schematic perspective view of a display device according to an embodiment of the invention. The display device is capable of displaying colour images and may be used in a number of applications, e.g. in a computer monitor or a TV set.

The display device comprises a light valve layer 1 including a large number of picture elements or pixels 3, e.g. 1280×720 or 1366×768 pixels. In a colour display the pixels in turn are divided into sub-pixels. The sub-pixel are arranged in columns for the primary colours red R, green G, and blue B, e.g. in the order red-green-blue-red-green-blue-etc. These sub-pixels constitute, together with sub-pixels with corresponding colours in pixels above and below, sub-pixel columns.

In a preferred embodiment the light valve layer is a liquid crystal layer. Then the light valve display device may be referred to as a liquid crystal display device. As is well known to the skilled person and not discussed further, the liquid crystal layer itself comprises a number of layers, such as polarising filters. In general, a light valve layer 1, such as the liquid crystal layer, is capable of individually modulating the light flow through its individual sub-pixels.

The display device comprises a backlighting arrangement 5, 7. This arrangement generates light that is projected onto the back (as seen from the user) of the light valve layer 1, which modulates the incident light in order to generate an image.

In accordance with an embodiment of the present invention the backlighting arrangement comprises a number of elongated light emitting structures 9, which extend in a layer 5 in a plane that is parallel with the light valve layer 1. A partial cross section along the line I-I is also shown in FIG. 1. Note that the elongated light emitting structures may be spaced apart a lot more, and need not abut each other as is shown in FIG. 1.

The elongated light emitting structures 9, which may comprise e.g. light guides, as will be described later, are parallel with each other. They emit light along their lengths and in the direction of the light valve layer 1.

The backlighting arrangement further comprises a number of elongated lenses 11 with convex cross section. The convex cross section of the lenses serves to concentrate incident light. These lenses are arranged in an optics layer 7 in a plane which is parallel with the light valve layer. The layer 7 of lenses is located between the light valve layer 1 and the layer 5 of elongated light emitting structures 9. The elongated lenses 11 extend in the same direction as the light emitting structures 9, such that each lens 11 focuses light emitted from a few light emitting structures 9, such as a light guides, onto a few elongated areas of the light valve layer 1. All lenses in the optics layer 7 may be formed integrally with each other, e.g. as a structured plastic plate.

Each light emitting structure 9 is preferably devised to emit light of one colour only. This light is emitted in the general direction of the light valve layer 1, so that it illuminates the elongates lenses 11 placed there between.

FIG. 2 shows a cross section of a preferred embodiment of the display device in FIG. 1. As can be seen, each light emitting structure illuminates a number of elongated areas, corresponding to sub-pixel columns 13, on the light valve 1 layer through a number of elongated lenses 11. As is evident from FIG. 2, this allows a much coarser spacing of the light emitting structures 9 compared to the spacing of the sub-pixel columns 13 in the light valve layer 1. Moreover, each sub-pixel column 13 is illuminated by a number of light emitting structures 9 from a corresponding number of angles and through a corresponding number of lenses 11, which serves to improve the uniformity of the illumination and the viewing angle of the display device.

FIG. 3a illustrates a preferred embodiment of the elongated, preferably cylindrical light emitting structures used in FIG. 1. In this embodiment, the light emitting structures 9 comprise light guides, which are each fed by a light source 10, such as a light emitting diode (LED). The light which enters the light guide is conveyed by the light guide by means of total reflection. Along the length of the light guide 9 and at the side facing the light valve layer 1, the light guide 9 is provided with notches or impurities that allow light in the light guide 9 to leak out. Preferably, the densities of such notches or impurities may be varied (e.g. as a function of the distance from the light source) over the length of the light guide 9 in order to obtain an even light emission over the entire length of the light guide 9. At the end 12 opposite to the light source, the light guide 9 may be provided with a reflective material in order to reflect light that reaches the end of the light guide back into the structure.

In FIG. 3a each light guide emits light of one of the primary colours red (e.g. with the wavelength 610 nm), green (e.g. 535 nm) and blue (e.g. 465 nm) only. This is preferred, since no colour filters are needed in a colour display as compared with white light that must be filtered. Using filter does not only require an extra layer, but also implies a waste of energy, since the greater part of the white light energy must be removed to obtain a primary colour.

FIG. 3b illustrates another embodiment where four “primary” colours are used namely red (R), “yellowish green” (green, G₁), “bluish green” (cyan, G₂, e.g. 505 nm) and blue (B), i.e. the colour cyan is added as compared with in FIG. 3a. This feature requires a corresponding modification of the light valve layer, where each pixel is subdivided into four sub pixels. Using four “primary” colours has the benefit of providing a greater colour gamut, which improves the colour reproduction of the display device.

FIG. 4 illustrates an alternative embodiment of the elongated light emitting structures used in FIG. 1. In this embodiment, the light emitting structures comprise light guides, and a bright light source, such as a emitting diode (not shown), is arranged to feed a number of light emitting structures with light of a predetermined colour. By a bright light source is meant a light source capable of feeding a number of elongated light emitting structures. As is schematically indicated in the drawing this may be obtained with fork-shaped light guide arrangements. The refractive index of the light guides must be considered when forming such light guides. Too sharp bends may cause light to escape in an undesired manner. Other shapes than the fork shape are conceivable, e.g. interleaved, meander-shaped light guides.

FIG. 5 illustrates another alternative embodiment of the elongated light emitting structures used in FIG. 1. In this embodiment each elongated light emitting structure comprises a column of light emitting diodes 14. The light emitting diodes of each such column are arranged in bars 9 and preferably emit light of one colour only. The spacing between the light diodes in a column may be decided depending on the power of the diodes used. This embodiment provides also the option to vary the light emission along each elongated light emitting structure 9, since the light emitting diodes 14, which define each light emitting structure, may be controlled individually.

In summary, the invention relates to a backlighting arrangement for a light valve display device, such as an LCD-display. The backlighting arrangement comprises a number of elongated light emitting structures, arranged in a plane, which emit light along their lengths in the direction of a light valve layer. An optics layer, comprising a number of elongated lenses, is placed between the light emitting structures and the light valve layer. Each such lens concentrates light emitted by a number of light emitting structures onto a number of elongated areas on the light valve layer. Preferably, each light emitting structure emits light of one primary colour only and the elongated lenses concentrates the light emitted from each light emitting structure onto sub-pixel areas intended for a corresponding colour, so that a colour display may be provided without the use of colour filters.

While the invention has been described in connection with various preferred embodiments, it should be understood that the invention should not be construed as being limited to those embodiments. The invention rather includes all variations which could be made thereto by a skilled person and within the scope of the appended claims. For instance, the order of the primary colours used may be altered arbitrarily. Moreover, the light emitting structures, the lenses and the sub-pixel columns may be arranged horizontally in rows instead of, as shown, vertically in columns.

1. Light valve display device, comprising:
a first plane, a second plain and a third plane, the first, second and third plane being generally parallel with each other, and the third plane being formed between the first and the second plane;
a light valve layer extending in the first plane;
a backlighting arrangement comprising a number of elongated light emitting structures formed in a layer extending in the second plane;
the light emitting structures have lenghs and are arranged to emit light along their lengths and in the direction towards the light valve layer;
the light emitting structures include a number of elongated lenses with convex cross sections, which are arranged in a layer extending in the third plane; and
the elongated lenses extend in the same direction as the light emitting structures, such that each lens focuses light emitted from a light emitting structures onto a portion of the light valve layer.

2. Light valve display device according to claim 1, wherein each lens focuses light from a plurality of light emitting structures onto a corresponding number of areas on the light valve layer.

3. Light valve display device according to claim 1, wherein each light emitting structure is devised to emit light of one colour only.

4. Light valve display device according to claim 3, wherein each of the light emitting structures emit light with one of the primary colours red, green and blue.

5. Light valve display device according to claim 3, wherein each of the light emitting structures emit light having one of the colours red, yellow-green, cyan-green and blue.

6. Light valve display device according to claim 1, wherein each light emitting structure comprises a light guide fed by a light emitting diode.

7. Light valve display device according to claim 1, wherein each light emitting structure comprises a light guide and wherein a bright light source is arranged to feed a number of light emitting structures.

8. Light valve display device according to claim 1, wherein each light emitting structure comprises a column of light emitting diodes.

9. Light valve display device according to claim 1, wherein the light valve display device is a liquid crystal display device and wherein a liquid crystal layer constitutes the light valve layer.

10. A liquid crystal display device, comprising:
a first plane, a second plain and a third plane, the first, second and third plane being parallel with each other, and the third plane being formed between the first and the second plane;
a liquid crystal layer extending in the first plane;
a number of elongated light emitting structures formed in the second plane, the light emitting structures have lengths and are arranged to emit light along their lengths and in the direction towards the liquid crystal layer;
the light emitting structures include a column of light emitting diodes having elongated lenses with convex cross sections and being arranged in a layer extending in the third plane;
the elongated lenses extend in the same direction as the light emitting structures and each lens focuses light emitted from the light emitting structures onto the liquid crystal layer.

11. A devices as set forth in claim 10, wherein the light emitting structures include a light guide and a bright light source, the bright light source is arranged to feed a number of light emitting structures.
